(19) United States
(12) Patent Application Publication
(10) Pub. No.: US 2018/0247358 A1
(43) Pub. Date: Aug. 30, 2018

(54) Methods and Systems for Designing Decorative Plant Arrangement

(71) Applicants: Sarah-Eva Ellen Marchese, Rockford, IL (US); Nathan Joseph Marchese, Rockford, IL (US)

(72) Inventors: Sarah-Eva Ellen Marchese, Rockford, IL (US); Nathan Joseph Marchese, Rockford, IL (US)

(21) Appl. No.: 15/821,843

(22) Filed: Nov. 24, 2017

Related U.S. Application Data
(60) Provisional application No. 62/403,142, filed on Oct. 2, 2016.

(51) Int. Cl. G06Q 30/06; A01G 5/00

(52) U.S. Cl. CPC G06Q 30/0621; G06Q 30/0641; A01G 5/00

(57) ABSTRACT

The invention is directed to methods and systems directed toward designing decorative plant compositions. By reducing design decisions for a plant composition into individual decision steps, the method or system may walk a user through a series of steps resulting in a design for a plant composition. Further, each step may alter, add, subtract, or determine the range of decision choice options for subsequent steps, thereby guiding the user in creation of the composition design. Upon completion of the series of decisions, the system may output a composition outline, blueprint, summary, or other description of the design, incorporating the user's design decision input. The individual steps in the series may comprise any or all aspects of plant composition design. The system may also be computerized to facilitate receipt and organization, transmission, and exploitation of design decisions.

### CROSS-REFERENCE TO RELATED APPLICATIONS

This application claims the benefit of U.S. Provisional Application No. 62/403,142; filed Oct. 2, 2016. Pursuant to 37 CFR 1.78(B)(1)(iii), the petitioners' failure to file this nonprovisional application seeking the benefit of the above referenced provisional application within the twelve-month period set forth in paragraph 37 CFR 1.78(a)(1)(i) was unintentional.

### COPYRIGHT NOTICE

A portion of this patent document's disclosure contains material that is subject to copyright protection. The copyright owner does not object to the facsimile reproduction by anyone of the patent document or the patent disclosure as it appears in the Patent and Trademark Office patent file or records, but otherwise reserves all copyright rights.

### BACKGROUND OF THE INVENTION

### 1. Field of the Invention

The invention is directed toward the field of decorative plant composition design. More specifically, the invention is directed toward guiding design decisions for decorative plant composition design and providing a means for individuals to generate a workable and usable decorative plant composition design regardless of level of experience or knowledge of decorative plant design.

### 2. Background of the Invention

### a. The Floral Design Industry and the Demand for Personalized Decorative Plant Compositions

The flower marketplace is a multibillion dollar industry. In the United States alone, billions of blooms are imported and hundreds of millions more domestically cultivated annually. According to industry research estimates, revenues in the United States floral market have been estimated at over $23 billion annually, with online floral sales alone accounting for approximately $3 billion in annual revenues.

Within this market, there is a strong demand from consumers for flowers customized to reflect their own personal sentiment and expressive intent. Cultures and civilizations throughout history have attributed symbolic significance to individual flowers. Though best known through the Victorian language of flowers, cultures and peoples have attributed symbolic meaning and expressive intent to various flowers since antiquity. In this way, flowers have come to play a central role in traditional ceremonial and social activities, notably nuptial and funeral ceremonies as well as serving as expressive gifts commemorating various occasions and events, such as Valentine's Day, Memorial Day, Mother's Day, Administrative Professionals' Day, and innumerable others. Likewise, there is a strong demand, particularly among the millennial generation, for personalized decorative plant compositions in a variety of aspects of their lives, from events, home decor, to personal attire and accessory style.

A 2009 study by the Society of American Florists indicates that younger generations, specifically the millennial generation, see flowers as a means of articulating their personal style both at home and work and in life events, such as their weddings or funerals. They see flowers as a way to enhance the style associated with their broader tastes or styles as expressed in their personal attire, home decor, and general views on life. Further, there is a strong demand that this personalized expression feel unique as opposed to a “cookie cutter” arrangement lacking individual features to distinguish it from previous designs, while maintaining a look and feel representative of the individual's personal style.

While the demand for customized plant compositions has always been present, current technology has made available a much broader range of customization options, and given current generations the expectation and desire to customize the style around them in a broader range of means than ever before. Indeed, studies indicate that one in five purchasers is willing to pay a twenty percent premium for customized goods.

Today's customization solutions embrace a range of composition options from custom textiles, home decor, floral arrangements, paper goods, and a wide array of other creative compositions reflecting the individual's design tastes and personal style. Examples of such customization solutions include: Custom Made (custom jewelry, home decor goods, and attire: http:///www.custommade.com/gallery/custom-jewelry/); Tulle & Chantilly (custom wedding attire: http://www.tulleandchantilly.com/design your own wedding gown.html?p=blog); Shoes of Prey (custom footwear: https://www.shoesofprey.com); CustomInk (custom t shirts: http://www.customink.com/); MegaPrint, Inc. (custom wallpaper and murals: http://www.megaprint.com/wallpaper.php); Spoonflower (custom wallpaper: http://www.spoonflower.com/designs/new?create=wallpaper); Vistaprint (custom paper goods and business products: http://www.vistaprint.com/custom-tshirts.aspx?couponAutoload=1&GP=8%2f5%2f2016+1%3a31%3a59+PM&GPS=4032633017&G NF=0); Night Owl Paper Goods (paper goods and wood crafts: http://nightowlpapergoods.com/); and countless other customization solutions.

For many of these customization and design services, the common hallmark is convenience, ease, and price. However, these solutions fall short in a number of ways with providing a patron tools with which to articulate design preferences, particularly for decorative plant compositions, and specifically with regard to the ability to identify features and components that satisfy their preferences or create their desired style, to identify the field of existing compositions and the creative space available to uniquely distinguish their composition design, without venturing outside their design style and preferences, and to develop a design that is suitable to being practically implemented by a floral design artisan.

One major limitation of these solutions is a lack of guidance and/or educational materials to empower the user in their design decisions: users have to know what they want and how they want it designed. According to a 2016 study by the Society of American Florists, “there is an education opportunity for local florists—less than one half of consumers indicate they know which flowers are appropriate for specific situations and regression analysis identified the providing of expert recommendations as a hidden opportunity.” Knowledge of individual flowers is only a part of the deficiency, however, as consumers have expectations regarding the overall style of their arrangements, which may be created through a number of design aspects, of which flower selection is but one. And when consumers or patrons of floral compositions know little to nothing about how to express their own design taste, style, or preferences, as is often the case with flowers, knowing what we want and how to ask for it can be impossible.

Despite their increased demand for personalized plant compositions, millennials know even less about flowers than preceding generations. Millenials not only know less about flowers, but less about floral style trends and, therefore, are less able to articulate their tastes, styles, and expectations for their bouquet preferences and design specifications, creating a major impasse to commissioning satisfying floral compositions.

For the first time in 2010, florists made it to Angie's List's top ten industries engendering the most complaints from customers. Follow-up surveys indicated that 85% of respondents had used florists for pre-made or customized arrangements. But 43% of those reported having more negative than positive experiences with florists.

Unfortunately, patrons and consumers of customized plant arrangements are often met with a number of limitations in the current technology, including limited customization options, lack of guidance for identifying their own style preferences, imprecise or vague classification terminology which causes miscommunications when articulating design specifications, and limited ability to provide specific, objective design criteria for design decisions. Furthermore, although there is a strong demand for individuals to play a hands-on role in developing a personalized design, there is a lack of knowledge about the available range of options in viable plant composition design or how to achieve a particular style or look in a composition. Accordingly, individual consumers are often forced to accept prefabricated, nonpersonalized arrangements, take massive risk in designing their own without any knowledge it if will actually look good, or, at best, are utterly reliant on of a commissioned designer's tastes, style preferences, and abilities for developing a design with little opportunity for meaningful input themselves.

Thus, despite the strong demand for expressive intent and personalized style through decorative plants, existing methods and systems for individuals to choose personalized, expressive flowers matching their customized vision are limited due to a number of challenges. These challenges include the organization of the flower industry and the nature of present computer technologies to emphasize information transmission as a visual medium without providing design guidance to enable individuals to participate in their own design decisions.

### b. State of the Art—Wire Service Networks and the Organization of the Commercial Floral Marketplace

Existing solutions to the issue of floral creative composition are inadequate to solve the issues enumerated above. The fundamental core of the problem resides in consumers' limited design and style expertise and knowledge foundation. While this has been true for countless generations, these problems are particularly acute in the millennial generation which simultaneously demands greater personalization than previous generations, but knows far less about flowers than their predecessors.

Currently, there are a number of solutions for acquiring ornamental and gift plants. Many of these solutions provide only pre-fabricated, preconstructed designs. These solutions fail to meet the personalization and customization needs of the industry because they lack any means of user personalization and input into plant arrangement design.

Initially, the floral design industry is fundamentally built on a system that gives the consumer little to no decision-making power. The traditional and near ubiquitous point of industry contact for a consumer of ornamental plants is the local floral shop. Typically, these shops are independently owned and operated and serve local communities by providing timely, fresh arrangements, plants and related gifts for a variety of occasions. While local shops often take individual orders for customized arrangements, particularly for events such as weddings or funerals, they often offer little in the way of guidance, education or instruction to assist a consumer in identifying what their personal style is and how to best communicate that style, frequently resulting in miscommunications and frustrated or disappointed customers.

In addition to processing orders directly, independent flower shops often maintain relationships with wire services which provide networks for these independent florists and facilitate the transfer of orders. The flower wire service operates as a national or global point of universal contact, through which consumers may place an order, which is, in turn, transferred to a participating florist shop in the consumer's desired area for fulfillment. This wire service is largely dominated by 1-800-Flowers, FTD, and Teleflora. Their relationship to independent floral shops is generally that of a middleman, taking orders and dispatching them to local neighborhood florists for fulfillment.

To maintain consistency of available products on a nationwide basis among the network of thousands of independently owned floral shops, these wire services maintain a standardized catalogue of pre-constructed plant composition designs. Flower purchasers select one or more of these pre-constructed arrangements based on representative images. The independent florist must then construct an arrangement meeting the specifications of the standardized arrangement ordered. Therefore, all participating network florists must maintain stock of flowers required to construct these arrangements. This system permits no room for arrangement personalization by either the consumer or the florists themselves.

While a number of alternatives to the traditional wire service network system have recently arisen in the marketplace, none of these alternatives offers substantially greater customization options for the flower consumer. One recent industry alternative is BloomNation (www.bloomnation.com), which operates as the self-described “Etsy” for flowers. Through their online marketplace, consumers can browse and order floral designs posted by local florists. While this system allows individual florists freedom to create their own designs, it does not offer consumers any additional utility to personalize arrangement designs themselves, particularly with regard to educating consumers about their design options and tastes or how to communicate their preferences to a florist.

Another alternative is Bouqs (www.bouqs.com), which acts as a direct-from-wholesaler point of contact for consumers. Through the Bouqs marketplace, consumers can browse and order preconstructed arrangements. Upon order, the flowers are cut and directly delivered, cutting out potentially multiple layers of the supply and distribution chain inherent in the traditional model. Again, however, this system does not provide any increased utility for personalization of floral design by the consumer. In fact, some of these new companies offer less variety of arrangement options than the wire companies before them.

### c. State of the Art: Manual Research of Photographic Resources

Consumers' most common point of entry to floral design is rote manual research by finding and looking at photographic images of bouquets. The most frequent resources to assist in locating bouquet images are online image search resources and traditional bridal or floral print publications and online blogs.

Online image search resources include search engines such as Google and Pinterest. Both these resources enable users to query terms and return images in response. These solutions are subject to a number of limitations, not least of which is that they provide no preliminary guidance in identifying the proper search terms which will return images in the user's desired style. Once images are returned, there is little or no guidance for classifying them by identifying the design look or style of the composition, the elements the composition is created from, the design characteristics of the composition itself or its elements, or guidance in identifying and locating similar compositions. Even when design composition elements are identified, it is up to the user to discern which compositions meet their style and taste, and what specific characteristics of the compositions give rise to the look and feel they identify with. Nor do these resources provide any guidance with the range of customization options by which users may alter a design or which common characteristics are available within a particular style that can be customized without taking the arrangement out of their target style or design look.

Bridal or floral print resources and blogs often provide some floral or style information about an individual composition, but also fail to provide comprehensive style guidance with which a user may make a design their own. They offer no information regarding the trendiness of a particular style or characteristic. They offer no information about alternative design options. And they provide no means to output a customized and implementable design.

Furthermore, research using mere photographic images is itself insufficient in a number of ways. Presenting one or several images to a florist as a means of articulating style is notoriously imprecise and often leads to miscommunications and dissatisfaction with the final composition. It is also a remarkably poor way for a consumer to obtain a unique design, as, by definition, a specification based on a photograph itself unavoidably relies on a floral composition design that had already been implemented to create the photograph.

Also, researching by simply powering through a volume of images is a particularly inefficient means of identifying and articulating one's design style. It can take dozens of hours to locate a sufficient volume of images and identify a user's preference. Even if a user were able to identify appropriate image resources, these took fail to provide a convenient and economical means of indexing hundreds or thousands of individual flowers or compositions across multiple characteristics to identify and articulate the user's style preferences.

Additionally, photographic resources are poor guides to what is and is not possible in floral design. They fail to provide any guidance as to the plants that are seasonally or commercially available on a given date or in a given location. They fail to specify the plant weights or shapes that may be compatibly designed with compatible structural components, such as wire or bouquet holders, in a particular bouquet structure.

### e. State of the Art—Floral Arrangement Imaging Technologies

Although traditional sources for decorative plan consumption fail to provide means of consumer customization, there are several services available providing floral personalization and customization utility. However, each of the existing solutions is inadequate to meet the consumer's need for customization and personalization in at least two important ways. First, none of the existing customization technologies provides design guidance with regard to either design principles to achieve a particular look and feel in a plant composition or guidance with what will constitute a practically implementable design composition. Second, due to the nature of modern telecommunications technology as an inherently visual medium, the existing customization technologies emphasize visual customization, but provide insufficient utility to customize on the basis of nonvisual criteria.

A number of services create visual representations of flower arrangements that a user can alter to create a customized virtual arrangement design. Such technologies have been disclosed in, for example, U.S. Pat. No. 5,440,479 (a floral kiosk ordering system with visual ordering information), U.S. Pat. No. 7,337,413 B1 (a system and method for designing a bouquet from selected images); U.S. Pat. No. 8,954,875 B2 (a method for providing a visual representation of floral arrangements by arranging selected images into templates); United States Patent Application Publications US 2006/0064314 A1 (a graphical user interface which combines images of selecting floral items); US 2009/0063302 A1 (a floral arrangement marketplace featuring a what-you-see-is-what-you-get interface displaying floral arrangements composed of selected images); US 2012/0198387 A1 (a computer-implemented method and tool for creating a virtual floral arrangement); US 2015/0019368 A1 (a floral arrangement customization system allowing a user to create and modify a customized floral arrangement); and World Intellectual Property Organization Patent WO 2012/005385 A1 (a method for customizing online flowers involving creation of a customized bouquet image). Comparable instantiations of these visual arrangement development tools are available online at Russian Flora (http://www.russianflora.com/bouquet-builder.php); the website of Interflora's United Bride (http://www.interflora.co.uk/myinterfloracreation.xml); Designed by the Bride (http://designedbythe bride.com/you-design/free-editor/); and centralpark.com (https://www.centralpark.com/virtual-bouquet/create).

While each of the above listed tools provides a means to visually arrange flower images into various combinations and configurations, none of the above utilities provides any further guidance in identifying and selecting flowers to use in a personalized arrangement, either with regard to developing a design with a particular look and feel, such as a “rustic” or “whimsical” arrangement, nor in terms of designing something which may be practically implemented by a floral design artisan. Additionally, they rely on a static database of flower images, which tend to be a selection of those commonly used flowers which have been popularized and made consistently available by their inclusion in the standardized bouquets in the wire service catalogue. As a result, consumer variety in flower selection in these solutions is limited in much the same way that it is limited in selecting bouquets through a local florist or wire service.

### f. Conclusion: a Solution is Needed to Address the Lack of Plant Composition Design Solutions

It would be desirable to have a solution which allows consumers to conveniently and economically play an active role in plant composition design. It would be desirable for that solution to provide guidance to facilitate the user's design to be practically implementable. It would further be desirable for the solution to assist users in identifying and achieving the look and feel they want for their arrangement. It would be desirable for the system to facilitate communicating the design to a florist or other individual to put together the composition based on the user's design. Accordingly, there exists a current need in the industry for a novel solution that provides greater access to plant composition design tools, solutions, and guidance to facilitate personalized designs by individuals regardless of their background or level of expertise with plant composition design.

### SUMMARY OF THE INVENTION

The invention is directed to methods and apparatus for designing decorative plant compositions.

Among the many different possibilities contemplated, each embodiment may advantageously comprise methods for decorative plant arrangement design involving a sequence of steps related to a series of arrangement design options. The user completes a step by making a design decision, in one embodiment by selecting an option from a range of options. Upon completing a step in the sequence, subsequent steps may be added, omitted, or have their range of possible input values changed or updated to correspond with one or more previous decisions. In this way, a method and system may walk step-by-step through a decorative plant arrangement design process, until a completed design is generated. Upon completion of the design, the system may output a composition outline, blueprint, visual approximation, video representation, or other description of the design, incorporating the user's input at each decision step of the process.

The system and method may include decision steps relating to one or more facets of decorative plant arrangement, including, without limitation, identifying the arrangement's arrangement type, design classification, structure, size, shape, presence or characteristics of structural components, composite elements or their properties, arrangement style, arrangement density, intended purpose, intended recipient, date of intended use, location of intended use, duration of intended use, plant selection criteria, and/or any other characteristics or criteria relevant to a plant composition's design and implementation. As a system, the invention may be manifest in a computerized network with a graphical user interface to facilitate the issuance of design decisions and receiving responsive input from a user.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

The present invention together with the above and other objectives and advantages may be best understood from the following description of a preferred embodiments of the invention, including the invention illustrations, wherein:

FIG. 1 shows a high level diagram of an exemplary computing system network on which the present invention may be implemented;

FIG. 2 shows a flow chart diagram for an exemplary routine for implementing a template which presents a user with a design decision and accepts input from the user responding to the decision; and

FIG. 3 shows a flow chart diagram for an exemplary routine executing a design decision presentation and receipt of responding user input.

It should be understood that the associated drawings and descriptions represent but one exemplary embodiment of the present invention. The ordering of the blocks of the illustrated flow charts could be rearranged or moved inside or outside of various routine loops by one skilled in the art. Likewise, various routines or blocks could be broken in to multiple steps for reasons of computational efficiency or ease of maintenance. These illustrations are not intended to limit the scope of the invention.

### DETAILED DISCLOSURE OF THE EXEMPLARY EMBODIMENTS OF THE INVENTION

The present invention relates to methods and computerized systems for a creating plant composition design.

The invention is designed to provide a series of sequential steps. In each step, a user specifies a design parameter for the creation of a plant composition. As the user inputs individual design parameters, choices or decisions at each step, the subsequent steps in the process are modified accordingly to ensure they are both practically capable of implementation with design choices made in previous steps and compatible in terms of the style or “look and feel” a user may specify. Upon conclusion of the series, the system may store and/or output a complete outline of design choices in a “blueprint,” guide, or other format which communicates the design decisions in a manner so as to make it comprehensible and easily implementable as by the designer, by a third-party who may be constructing the composition, by the system itself, or by some other means of creating a composition based on the design.

The end result of this system is a means for users to create a practical and implementable plant composition design in accordance with their own style or “look and feel” specifications, regardless of their background in or level of design experience and taste.

### I. System Architecture Overview

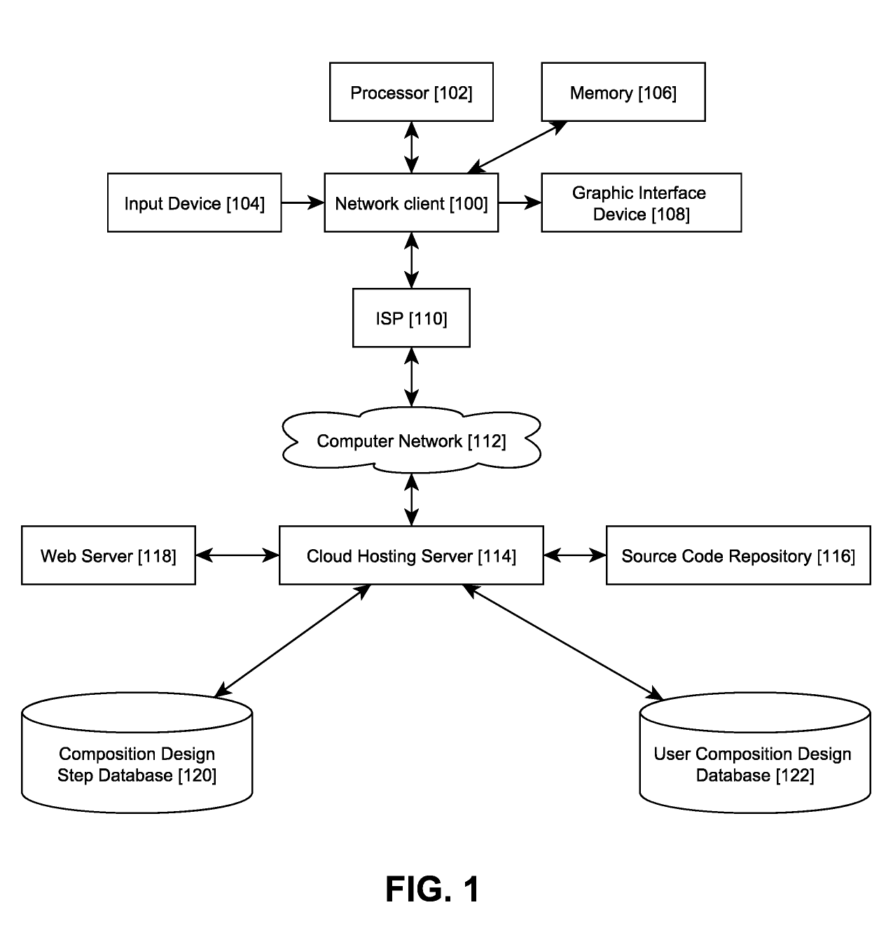

Aspects of the present invention may be implemented on one or more computers executing software instructions. FIG. 1 illustrates an embodiment of the computer system that may be used in one embodiment of the present invention. In the one embodiment, the system of the present invention may be made up of the following components: a network client including a processor, data storage memory, graphical user input display device, alpha-numeric input device, cursor control input device, memory, and/or text output device, a web server computing system, a cloud hosting server, a code source repository, and computer readable data storage medium(s) containing one or more databases.

These components are combined together to create an architecture for the system in which the server computer system transmits and receives data over a computer network or a standard telephone line. The server computer's central processing unit (CPU) executes sequences of instructions to perform the steps of accessing, receiving, storing, transmitting, downloading, or otherwise manipulating the data, as well as other aspects of the present invention. The CPU functions by executing sequences of instructions stored in memory in the code repository. The CPU memory may be in the form of random access memory (RAM), read-only memory (ROM), a persistent store, such as a mass storage device, or any combination of these. Execution of the sequences of instructions causes the CPU to perform steps according to embodiments of the present invention.

The present invention is not limited to any specific combination of circuitry and software, or to any particular source for the instructions executed by the server or client computers. In various embodiments of the system, the instructions may be loaded into the server computer memory from a storage device, from one or more other computer systems over a network connection, from the server computer's own memory storage, or any other source. The instructions may be downloaded and interpreted directly by the server CPU, or may be executed by an interpreter that transforms the instructions into a format readable to the CPU. In some embodiments, part or all of the instructions are embodied in hardwired circuitry in the system.

FIG. 1 illustrates a computer network system that implements one or more embodiments of the present invention. As demonstrated in FIG. 1, a network server computer 118 is coupled, directly or indirectly, to one or more network client computers 100 through a network 110. Network 110 may be the Internet, a Wide Area Network (WAN), a Local Area Network (LAN), intranet, extranet, wireless network, or any combination thereof.

FIG. 1 includes a client computer 100, which, in an exemplary embodiment may be, by way of example and not limitation, a personal computer (PC) system running an operating system. This operating system may be, by way of example and not limitation, Microsoft Windows, Apple Mac/OS, Apple iOS, LINUX, Android, etc. However, the invention may be implemented on any appropriate computer system running any appropriate operating system, such as a computing device, telephone, personal digital assistant (PDA), a smart phone, an iPhone, a handheld PC, proxy servers, network communication servers, etc.

The client computer 100 includes software and hardware for generating a graphical user interface (GUI) and display signals, for rendering on a GUI display 108. The client computer 100 receives input signals, such as queries, instructions, commands, etc., via input device(s) 104, which may be a keyboard, a mouse, a touchpad, a scanner, a touch screen, etc.

The client computer may include input/output (I/O) devices (not shown in FIG. 1) such as, by way of example and not limitation, network interface card, modems, network interface, communications port, transceiver, etc. to allow software and data to be transferred between computer system 100 and external devices.

The computer system 100 may also include one or more processors 102. The computer system 100 may also include, e.g., but may not be limited to, memory storage medium or device 106, such as, by way of example and not limitation, random access memory (RAM), a hard disk drive, removable storage drive, and/or any data storage medium which may be read from and written to by the computer system 100.

The network interface between server computer 118 and client computer 100 may also include one or more routers. The routers serve to buffer and route the data transmitted between the server and client computers.

In one embodiment of the present invention, the server computer 118 is a World-Wide Web (WWW) server that stores data in the form of ‘web pages.’ The server computer then transmits the stored web pages as Hypertext Markup Language (HTML) files over the Internet network 112 to one or more of the client computers 100. In one embodiment, the client computer(s) 100 interpret and display the web pages served by the server computer 118 via “web browser” programs. Additional web based content can be provided to a client computer 100 by separate content providers, such as a supplemental server 114.

In one embodiment of the present invention, server 118 in the system is a server that executes an information retrieval and transmission process. The information retrieval and transmission process involves the receipt and transmission of data from various client computers, such as network client 100, and processes the received data to process requests received over network 112. The information retrieval and transmission process may represent one or more executable program modules or applications stored within cloud hosting server 114 and executed locally within the server. Alternatively, the information retrieval and transmission process may be implemented in a plurality of different program modules, each of which may be executed by two or more distributed server computers coupled to each other, or to network 112 separately. In a further alternative embodiment, information retrieval and transmission process may be stored on a remote storage or processing device coupled to server 118 or network 112 and accessed by server 118 to be locally executed. It should be noted that a network system 114 that implements embodiments of the present invention may include a larger number of interconnected client and server computers than shown in FIG. 1.

Unless specifically stated otherwise, as apparent from the following discussions, it may be appreciated that throughout the specification discussions utilizing terms such as “processing,” “computing,” “calculating,” “determining,” “manipulating,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

According to an exemplary embodiment, exemplary methods set forth herein may be performed by one or more computer processor(s) adapted to process program logic, which may be embodied on computer accessible storage medium, which when such program logic is executed on the exemplary one or more processor(s) may perform such steps as set forth in the exemplary methods.

### II. User Interfaces

In order for a user to effectively interact with the system, the system may provide a user interface comprised with GUI objects to facilitate interaction with the system.

In one embodiment of the invention, the system provides two separate user interface GUI formats: an individual user GUI (e.g., for consumers or patrons of compositions) and a system administrator interface (e.g., for those tasked with overseeing the operation of the computer site). Each such interface may enable users, for example, to access the system's database(s) to either query data stored within the database(s), transmit instructions to process and return data stored in the database(s), and/or enter or otherwise manipulate information into the database(s). It is important to note that alternative embodiments of the invention may involve additional, different, or other GUIs specialized for different purposes, such as, for example, GUI objects for florists, GUI objects for floral designers, GUI objects for bridal industry consultants, GUI objects for consumers seeking to acquire plants to use as gifts, GUI objects for brides, GUI objects for particular occasions, GUI objects for flower farms, GUI objects for flower sellers, GUI objects for flower transporters, GUI objects for delivery drivers, etc. Other embodiments of the invention may not include some of the GUI objects described herein, such as the creator GUI.

Each of the system's interfaces may employ a combination of instructions to display the GUI interface and enable access to various system functionality. Said instructions may be recorded in any computer readable medium such as, by way of example and not limitation, HTML, PHP, CSS, XHTML, Flash, and/or Ajax. It will be understood that the interfaces may be implemented in any computer readable means which enables convenient and efficient human interaction with the system, including applications, executable program files, and the like.

The individual user (i.e., composition design creator) interface may include, for example and not by way of limitation, GUI elements providing functionality described more fully below, but generally designed to facilitate posing a series of design options to a user, information (including visual imagery, video, or audio content) necessary to competently complete the design choice, and a means of facilitating receipt of user input related to their design choice at that each stage of the series. Individual user GUI objects may also enable users to access detailed information on exemplary plant compositions, plant composition properties, plant composition classifications, plant composition elements, or plant composition element properties. Additionally, the GUI objects may include functionality enabling users to communicate directly with composition creators (e.g., florists, designers, artists, etc.) for the purpose of establishing custom composition requests or personalized design composition fulfillment, inquiring regarding current price, design specifications, and the like.

In one embodiment, the system may include an administrator interface. The system administrator interface may include means for administrators to execute command and control oversight over the computer site's operations. By way of example, and not limitation, this functionality may include interacting with data contained in the site database(s). The administrator GUI may enable administrators to access and analyze data about users in the system, including their current and historical site navigation activity, their user account details, IP information, etc. The administrative interface may also enable administrators to analyze data about the system's information flow and load overall. The administrative interface may display and modify user permissions and access of various users to certain content or functionality at a given time.

In one embodiment, the system may include a decorative plant design artisan's interface. The artisan's interface may include means for an individual physically constructing a composition based on a composition design created by way of the individual user interface to construct a decorative plant design based on the design creator's specifications. The artisan's interface may include a list of each design choice input by the design creator in the design creator interface. The artisan interface may further include visual composition creation aids, such as a computer generated visual approximation of the user's design or photographs of past compositions with characteristics in common with those included in the user's design. The artisan's interface may also include lists of specific instructions for executing one or more particular aspects of a user's design choices in the plant composition.

In some embodiments, the artisan's interface may include quality control mechanisms including optical pattern recognition to ensure artisan's compliance with design guidelines. In some embodiments, the quality control mechanisms may involve quality guidelines established and input by the system administrator and input into the system via the system administrator interface. In some embodiments, the quality control mechanisms may include optical pattern recognition software or other tools to visually match characteristics of a composition with a user's design choices.

In some embodiments the artisan's interface may include tools to facilitate communications between the artisan and the design creator. This communication may be desirable, for example, to clarify any ambiguities that may exist in the design or based on instructions input by the design creator in the design creator interface. The communication may also be desirable, for example, to allow an artisan to provide particular design guidance or recommendations to ensure an aesthetically pleasing composition.

### III. Design Decision Series Overview

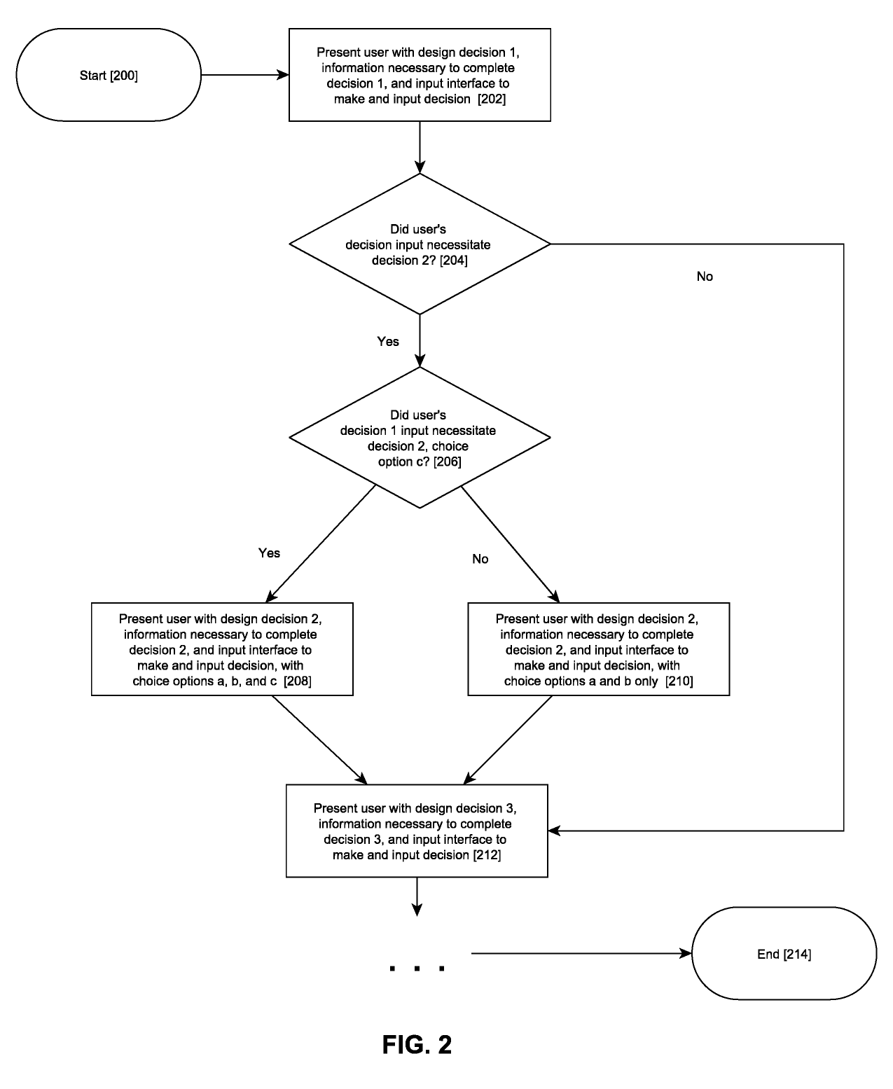

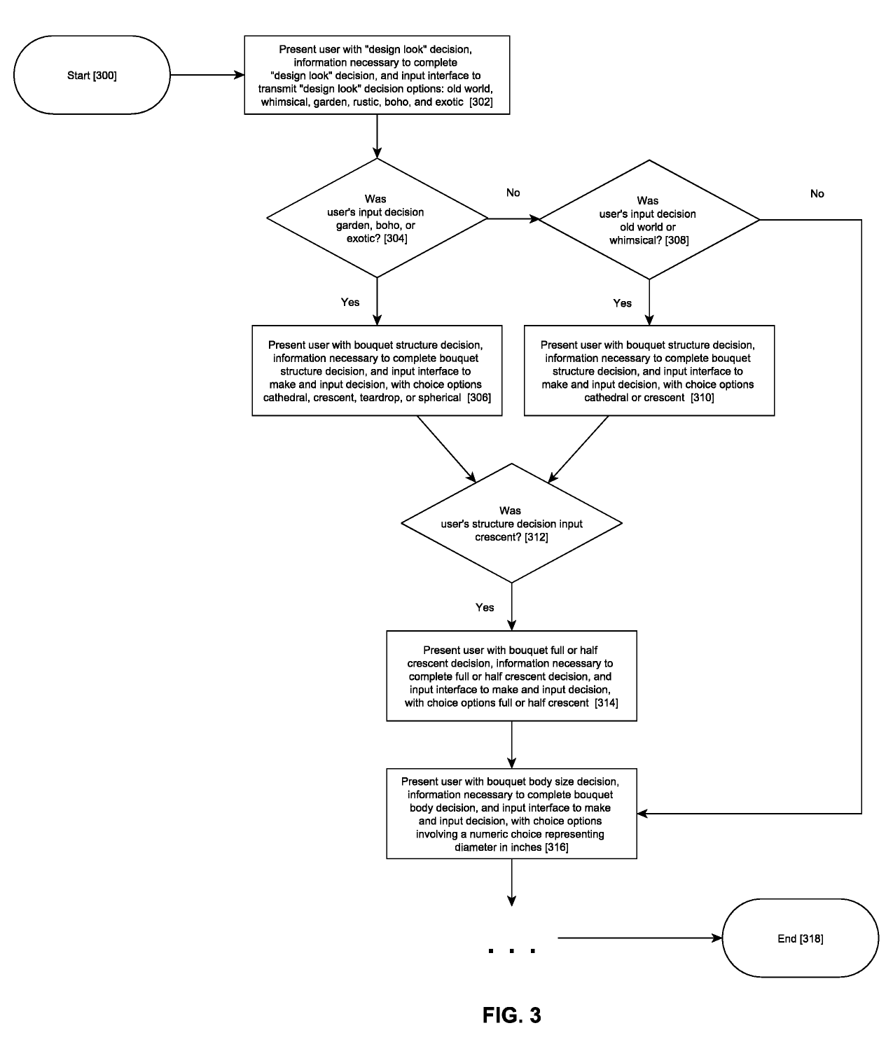

In order to present the user with a series of design choices and facilitate receipt and processing of user input, the system may involve one or more routines to facilitate presenting the user with a graphical user interface (“GUI”) presenting design choices and facilitating receipt of responses. FIG. 2 is a flowchart diagram demonstrating a template of the functionality of an exemplary embodiment of the invention. FIG. 3 is a flowchart diagram demonstrating an exemplary embodiment of the method's decision series routine execution.

The query in the embodiment illustrated in FIG. 2 includes various processes that coordinate the basic steps of presenting a design decision to the user [202], presenting the user with data or information necessary to competently make a choice with respect to the presented design decision [202], facilitating input, transmission, receipt and processing of the user's design decision choice [202], and issuing the next decision in the series [208, 210, 212], with the subsequent decision's input choices and the decision itself altered as appropriate based on previous input [204, 206, 208, 210, 212].

The exemplary decision process illustrated in FIG. 3 demonstrates a specific embodiment of the process demonstrated in FIG. 2. In the initial design decision, the user is presented with a choice of “design look,” with a set of options including “old world,” “whimsical,” “garden,” “rustic,” “boho,” or “exotic” [302]. Along with the decision, the user is presented information necessary to make a selection, which may be in the form of text, visual imagery, video, audio, or any other form without limitation [302]. The system also presents the user with a means of making a selection and transmitting the selection [302]. The particular design look selection may alter which design decision is presented next in the sequence, or which choice options are available in the next decision [304, 306]. If the user selects “garden,” “boho,” or “exotic” in the design look decision step, they are presented with a selection of “bouquet structure” including all structure options available to “garden,” “boho,” or “exotic” bouquets, those being cathedral, crescent, teardrop, or spherical [304, 306]. If the user selects for design look “old world” or “whimsical,” the bouquet structure decision is presented, but it offers only choice options for “cathedral” or “crescent,” since “teardrop” or “spherical” choices are incompatible with old world or whimsical style bouquets [308, 310]. If the user selects the “rustic” design look, they are not presented with a “bouquet structure” choice at all, since only “teardrop” structure is compatible with rustic bouquets, and cathedral, crescent, and spherical structures are not an option. Next, if the user selected a crescent structure, they are prompted with a choice to determine whether they will use a full or half crescent structure [312, 314]. Next, if the user input a “rustic” design look at step 302, a structure other than “crescent” at steps 306 or 310, or either full or half crescent at step 314, they are presented with the next design choice in the sequence, “bouquet body size,” along with any information necessary to make that decision, and a means of inputting a numeric value with represents the diameter of the bouquet body in inches [316]. For those skilled in the art, it will be apparent that this series of questions is presented only as an exemplary embodiment of the invention, and the invention could include different steps, different choice options, different input formats, different rules or decisions, different sequences of steps, different orders of choice options, or may otherwise vary in a number of particular system elements without altering its fundamental functionality or jeopardizing its ability to guide users through the plant composition design process.

In one embodiment, the range of design decisions which may be presented through the system may include, by way of example and not limitation, design look, arrangement structure, size and shape of parts of an composition (e.g., shower, radiation, body, handle, accessories, shoots, etc.), size and shape of the overall composition, arrangement of plants, intended use or purpose for composition, intended recipient of composition, composition use date, composition use venue, and other composite elements within the composition, choice of particular plants and other elements in the composition, including based on the properties of those elements, such as size, shape, width, color, growing season, commercial availability, price, etc., and among many other possible characteristics of plants or plant arrangement compositions.

### IV. Alternative Embodiments

It will be understood that various modifications can be made to the embodiments of the present invention herein disclosed without departing from the spirit and scope thereof. The invention may be directed toward one or more computer systems capable of carrying out the functionality described herein, and may find applicability in any computing or processing environment with any type of machine that is capable of running machine-readable instructions. For example, the principles of the invention may apply to other computer applications, such as other mainframes, minicomputers, network servers, personal computers, handheld mobile units or computing devices, as well as other electronics applications. Also, various modifications may be made in the configuration of the parts and the steps of the process. Therefore, while the discussion herein focuses on a particular application, it should be understood that the invention is not limited to the particular hardware designs, software designs, communications protocols, performance parameters, or application-specific functions disclosed herein.

A person skilled in the art will appreciate that the method and system of the present invention may be utilized in environments other than the Internet. The invention may be implemented using computer programming or engineering techniques including computer software, firmware, hardware or any combination or subset thereof. Any such resulting program, having computer-readable code means, may be embodied or provided within one or more computer readable media, thereby making a computer program product, i.e., an article of manufacture, according to the invention. The computer readable media may be any data storage device that can store data, which thereafter can be read by a computer system, such as, for example, a fixed (hard) drive, diskette, optical disc, magnetic tape, semiconductor memory such as read-only memory (ROM), etc., or any transmitting/receiving medium such as the Internet or other communications network or link.

Likewise, while the embodiments described herein are described in terms of interface programs that utilize web server and web browser programs, these document production processes may be implemented as proprietary or dedicated software programs that communicate over public or private computer networks coupling the on-line project management system to users.

The computer readable storage medium containing the computer code may be made, used, and/or distributed by executing the code directly from one medium, by copying the code from one medium to another medium, or by transmitting code over a network. An apparatus for making, using or selling the invention may be one or more processing systems including, but not limited to, a central processing unit (CPU), memory, storage devices, communication links and devices, servers, I/O systems, including software, firmware, hardware or any combination or subset thereof, which embody the invention as set forth in the claims. User input may be received from the keyboard, mouse, pen, voice, touch screen, or any other means by which a human can input data to a computer, including through other programs such as application programs.

All or part of the system can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Specifically, it will be appreciated that one or more of the methods employed in the above described embodiment of the invention may be realized as computer executable code created using a structured programming language, object oriented programming language, markup language, or any other high-level or low-level programming language that may be stored, compiled or interpreted to run on a data processing apparatus, as described above, as well as heterogeneous combinations of processors, processor architectures, or combinations of different hardware and software, including, without limitation, C, C++, Visual Basic, HTML, XHTML, Java, VBScript, Jscript, BCMAscript, Javascript, DHTM1, XML, CGI, ASP, assembly language, hardware description languages, or database programming languages and technologies, including, without limitation, MySQL, Microsoft SQL Server, IBM AS 400 or the like.

All or part of the computer system can be implemented in a computing system that includes a back-end component, e.g., as a data server, or that includes a middleware component, e.g., and application server, or that includes a front-end component, e.g., a client computer having a graphical user interface or a web browser through which a user can interact with an implementation of the plant search and indexing system, or any combination of such back-end, middleware, or front-end components. The components of the system can be interconnected by any form or medium of digital data communication, e.g., a communication network. Examples of communication networks include a LAN and a WAN, e.g., the Internet.

Method steps associated with the system can be rearranged and/or one or more such steps can be omitted to achieve the same, or similar, results to those describe herein. Individuals skilled in the art will easily be able to combine the software created as described with appropriate general purpose or special purpose computer hardware to create a computer system or computer sub-system embodying the method of the invention. Individuals skilled in the art will also envision other modifications within the scope and sprit of the present invention as defined by the drawings and descriptions set forth herein.

Therefore, it should be understood that the breadth and scope of the described invention should not be limited by any of the above-described exemplary embodiments. The examples and embodiments described herein are for illustrative purposes only and that various modifications or changes in light thereof will be suggested to persons skilled in the art and are to be included within the spirit and purview of this application and the scope of the described invention. The breadth and scope of the described exemplary embodiments should be defined only in accordance with the claims of any patent application(s) claiming the priority and benefit of this provisional application, which claims are incorporated herein by reference.

What is claimed is:

1. A method of floral arrangement design, comprising: two or more steps, a first step comprising selecting a choice or decision related to plant composition design, one or more second or subsequent steps comprising a choice or decision related to plant composition design, wherein the first choice determines or otherwise impacts the second and subsequent choices.

2. The method of claim 1, wherein the first choice determines or otherwise affects the design choice options available in completing the second and subsequent choices.

3. The method of claim 1, wherein the second choice determines or otherwise impacts the subsequent choices.

4. The method of claim 1, wherein the second choice determines or otherwise impacts the design choice options available in completing the subsequent choices.

5. The method of claim 1, wherein as a result of completing the first, second, and subsequent steps, the user completes a decorative plant arrangement design.

6. The method of claim 5, wherein as a result of completing the decorative plant arrangement design, the user produces a design composition outline, blueprint, or other description of the design incorporating the choices made for each step.

7. The method of claim 1, wherein one of the first, second, or subsequent steps relates to the design classification of a decorative plant composition.

8. The method of claim 1, wherein one of the first, second, or subsequent steps relates to the structure of a decorative plant composition.

9. The method of claim 1, wherein one of the first, second, or subsequent steps relates to the size and/or shape of a decorative plant composition.

10. The method of claim 1, wherein one of the first, second, or subsequent steps relates to the presence or absence of one or more structural components of a decorative plant composition.

11. The method of claim 1, wherein one of the first, second, or subsequent steps relates to the shape, size, or other design characteristics of one or more structural components of a decorative plant composition.

12. The method of claim 1, wherein one of the first, second, or subsequent steps relates to the composite elements of a decorative plant composition.

13. The method of claim 1, wherein one of the first, second, or subsequent steps relates to the properties of one or more composite elements of a decorative plant composition.

14. The method of claim 1, wherein one of the first, second, or subsequent steps relates to arrangement style of one or more composite elements of a decorative plant composition.

15. A computerized system comprising: a network interface unit configured to communicate with a network; a plurality of processors, each with an associated memory, in communication with the network interface unit; computerized instructions for providing a user a series of design decisions; a means of receiving design decision input.

16. The system of claim 15, wherein: the computerized instructions are configured so as to alter the series of design decisions presented to the user in response to user input.

17. The system of claim 15, wherein: the computerized instructions are configured so as to receive user input in response to each decision entered in response to a design decision presented to the user, and to add or omit subsequent design decisions on the basis of the user input.

18. The system of claim 17, wherein: the computerized instructions are configured so as to add, omit, restrict, limit, or otherwise modify the range of permissible user input in response to a design decision on the basis of a user's response to one or more previously input design decisions.
